(19) United States
(12) Patent Application Publication
(10) Pub. No.: US 2003/0141100 A1
(43) Pub. Date: Jul. 31, 2003

(54) Flat shield cable

(75) Inventor: Atsuo Tanaka, Nagoya-shi (JP)

Correspondence Address: OLIFF & BERRIDGE, PLC, P.O. BOX 19928, ALEXANDRIA, VA, 22320, US

(73) Assignee: AUTONETWORKS TECHNOLOGIES, LTD., Nagoya-shi (JP)

(21) Appl. No.: 10/305,948

(22) Filed: Nov. 29, 2002

(30) Foreign Application Priority Data
Jan. 29, 2002 (JP) 2002-020641

(51) Int. Cl. H01B 11/02

(52) U.S. Cl. 174/117 F

(57) ABSTRACT

To provide a flat shield cable capable of effectively preventing a buckle and a disconnection of the core conductors of signal lines even if an insulating sheath is thinned and thereby increasing the degree of freedom of wiring. A flat shield cable is characterized in that a drain line is provided on one side of a plurality of, parallel signal lines each having an insulating cover and the drain line and the signal lines are covered with a shield layer, which is covered with an insulating sheath; and that the width of the insulating sheath is so adjusted that the cable has a section modulus z of 4.1 to 5.8.

### BACKGROUND OF THE INVENTION

1. Field of Invention

The present invention relates to a flat shield cable. In particular, the invention relates to a flat shield cable that is suitably used for electrical connection to electric equipment, etc. of vehicles such as automobiles.

2. Description of Related Art

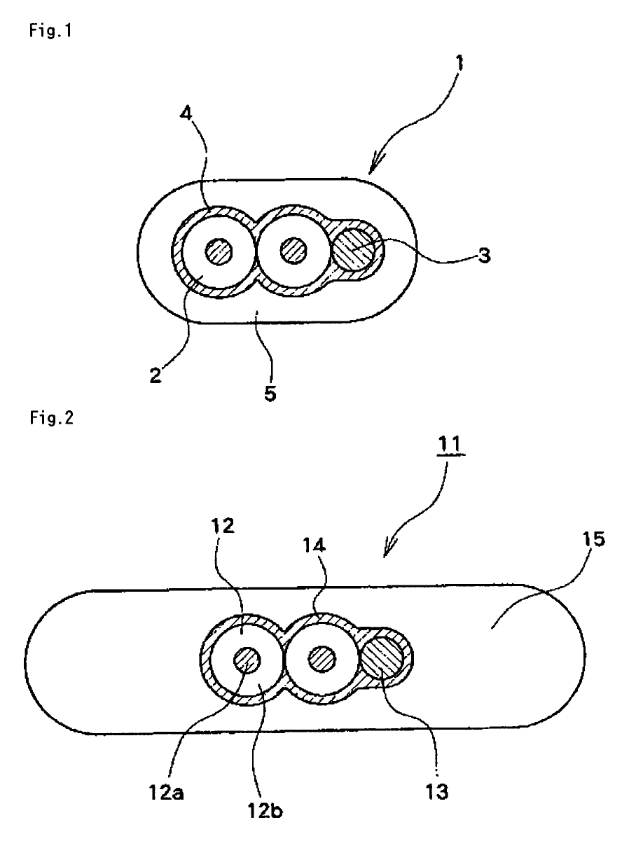

In vehicles such as automobiles, many shield cables are used for electrical connection to electric equipment, etc. In recent years, flat shield cables have come to be used from the viewpoint of space saving, etc. FIG. 1 shows the structure of an exemplary conventional flat shield cable.

This conventional flat shield cable 1 has a flat structure in which a plurality of signal lines 2 each having an insulating cover and a drain line 3 are arranged parallel with each other, and the signal lines 2 and the drain line 3 are covered with a shield layer 4, which is covered with an insulating sheath 5.

With this structure, external noise is interrupted by the shield layer 4 and led to an external ground via the drain line 3, whereby good signals are supplied to various kinds of electric equipment through the signal lines 2.

Incidentally, in recent years, to reduce the size and weight further, the thickness of the insulating sheath 5 has been reduced to about 0.3 mm. On the other hand, the flat shield cable 1 may be bent in its width direction during its wiring. When the flat shield cable 1 is bent in this manner, the core conductor of an outside signal line 2 is elongated by the bending. After it is returned to the original state, the core conductor remains elongated due to plastic deformation. This results in a buckle and the core conductor may be disconnected in the worst case. This problem is particularly remarkable in the above-mentioned flat shield cable 1 with the thinned insulating sheath 5.

### SUMMARY OF THE INVENTION

An object of the present invention is to solve the above problem in the art and thereby provide a flat shield cable capable of effectively preventing a buckle and a disconnection of the core conductors of the signal lines even if the insulating sheath is thinned and thereby increasing the degree of freedom of wiring.

To attain the above object, the present invention provides a flat shield cable characterized in that a drain line is provided on one side of a plurality of, parallel signal lines each having an insulating cover and the drain line, and the signal lines are covered with a shield layer, which is covered with an insulating sheath; and that the width of the insulating sheath 15 is so adjusted that the cable has a section modulus z of 4.1 to 5.8.

### BRIEF DESCRIPTION OF THE DRAWINGS

A sectional view showing the structure of an exemplary conventional flat

A sectional view showing the structure of a flat shield cable according to an the present invention.

### DETAILED DESCRIPTION OF PREFERRED EMBODIMENTS

A preferred embodiment of the present invention will be hereinafter described.

FIG. 2 is a sectional view showing the structure of a shield cable according to an embodiment of the invention.

The flat shield cable 11 according to this embodiment has a flat structure in which a plurality of (in this embodiment, two) signal lines 12 each having an insulating cover and a drain line 13 (provided on one side thereof) are arranged parallel with each other and covered with a shield layer 14, which is covered with an insulating sheath 15. Each signal line 12 is composed of a core conductor 12a and an insulating cover 12b.

This embodiment is characterized in that the width of the insulating sheath 15 is so adjusted that the flat shield cable 11 has a section modulus z of 4.1 to 5.8.

The relationship between the bending stress σ_{B} (kg/mm²), the bending moment M (kgf·mm), and the section modulus z (mm³) is given by the following Equation (1):

σ_{B}=M/z (1)

As seen from Equation (1), where the bending moment M is constant, the bending stress σ_{B} decreases and the structure becomes more difficult to bend as the section modulus z increases. The section modulus z (mm³) of the flat shield cable 11 whose sectional shape is shown in FIG. 2 is given by the following Equation (2):

z=a·b²/6 (2)

where a (mm) is the cable width and b (mm) is the cable thickness.

It is preferable that the section modulus z of the flat shield cable 11 be 4.1 to 5.8 mm³ and it is even preferable that the section modulus z of the flat shield cable 11 be 4.3 to 5.6 mm³. If the section modulus z is smaller than the above range, the desired effect cannot be obtained. If the section modulus z is greater than the above range, a problem arises that relates to the cost (material cost).

Incidentally, the section modulus z of the conventional flat shield cable is about 2.7 mm³. The section modulus z of the flat shield cable according to the invention is set to about 1.5 to 2.2 times of it.

The outer diameter of each signal line 12 is set as appropriate so as to be suitable for a use, and is usually equal to about 1.27 to 1.40 mm. From the viewpoint of size and weight reduction, it is preferable that the cross-sectional area (conductor size) of the core conductor 12a be about 0.05 to 0.13 mm². However, the invention is not limited to such a case. The core conductor 12a may be made of a metal or alloy material such as copper, aluminum, or Sn-plated copper and may be either twisted wires or a single wire.

The insulating cover 12b of each signal line 12 may be made of any of various resin materials such as poly(vinyl chloride) (PVC), polyethylene (including a foaming type), halogen-free materials, and polytetrafluoroethylene. The thickness of the insulating cover 12b of each signal line 12 is set as appropriate in accordance with the conductor size of the core conductor 12a.

The number of parallel signal lines 12 can be set arbitrarily so as to be suitable for a use.

The drain line 13 is made of a metal or alloy material such as annealed copper or Sn-plated copper and may be either twisted wires or a single wire. The conductor size of the drain line 13 is about 0.22 to 0.37 mm².

The shield layer 14 is made of a material that exhibits a shielding effect. Specifically, the shield layer 14 may be made of copper foil/PET tape, Sn-plated copper foil/PET tape, aluminum foil/PET tape, or the like and has a thickness of about 15 to 21 μm.

The insulating sheath 15 is made of a material that is insulative, oil-resistant, and chemical-resistant. Resin materials such as poly(vinyl chloride), polyethylene, halogen-free materials, and polytetrafluoroethylene may be used. From the viewpoint of size and weight reduction is preferable that the thickness of the insulating sheath 15 be about 0.3 to 0.4 mm. However, the invention is not limited to such a case.

Actually produced examples of the flat shield cable according to the invention and the conventional flat shield cable will be compared below.

(Cable of the Invention)

A flat shield cable according to the invention (width: 8 mm; thickness: 2 mm) was produced in which a drain line 13 (material: Sn-plated copper; conductor size: 0.22 mm²) and two signal lines 12 (material: Sn-plated copper; conductor size: 0.08 mm²) were arranged parallel with each other and were covered with a shield layer 14 (material: Cu/PET; thickness: 15 μm) and an insulting sheath 15 (material: a halogen-free material; thickness: 0.3 mm; width: 0.3 mm).

(Conventional Cable)

A conventional flat shield cable was produced that is the same as the above flat shield cable according to the invention except that the width of the insulating sheath, that is, the width of the cable, is 4 mm.

The cable according to the invention and the conventional cable had section moduli z of 5.3 mm³ and 2.7 mm³, respectively. When bending stress was applied to the above flat shield cables, the number of times of bending needed to disconnect a signal line was 1.5 times larger in the cable according to the invention than in the conventional cable, which confirms the superiority of the cable according to the invention.

By virtue of the employment of the above configuration, the invention can effectively prevent a buckle and a disconnection of the core conductors of the signal lines even if the insulating sheath is thinned and can thereby increase the degree of freedom of wiring. The invention can also prevent a disconnection due to insufficient strength even if the conductor size of the core conductors of the signal lines is reduced and can thereby reduce the size and weight.

The present application claims priority to Japanese Application No. 2002-020641, filed on Jan. 29, 2002, the disclosure of which is herein expressly incorporated by reference in its entirety.

While this invention has been described in conjunction with the specific embodiments above, it is evident that many alternatives, combinations, modifications, and variations are apparent to those skilled in the art. Accordingly, the exemplary embodiments of this invention, as set forth above are intended to be illustrative, and not limiting. Various changes can be made without departing from the spirit and scope of this invention.

What is claimed is:

1. A flat shield cable comprising:
a plurality of parallel signal lines each of the signal lines having an insulating cover;
a drain line disposed on one side of the signal lines;
a shield layer covering the signal lines and the drain line; and
an insulating sheath covering the shield layer, wherein
a width of the insulating sheath is so adjusted that the flat shield cable has a section modulus z of 4.1 to 5.8.
